(19) United States
(12) Patent Application Publication
(10) Pub. No.: US 2016/0254692 A1
(43) Pub. Date: Sep. 1, 2016

(54) ELECTRONIC DEVICE FOR WIRELESSLY CHARGING

(71) Applicant: Samsung Electronics Co., Ltd., Gyeonggi-do (KR)

(72) Inventors: Igor SHCHERBATKO, Gyeonggi-do (KR); Jaehoon KIM, Gyeonggi-do (KR)

(21) Appl. No.: 15/051,796

(22) Filed: Feb. 24, 2016

(30) Foreign Application Priority Data
Feb. 26, 2015 (KR) 10-2015-0027389

(51) Int. Cl. H02J 7/02; H02J 50/40; H04B 1/3827

(52) U.S. Cl. CPC H02J 7/025; H04B 1/3833; H02J 50/40

(57) ABSTRACT

An electronic device comprises a substrate; a main coil mounted on the substrate; and at least one auxiliary coil disposed near the main coil and electromagnetically coupled to the main coil, wherein the main coil is configured to receive an electromagnetic field generated by the at least one auxiliary coil.

### CLAIM OF PRIORITY

The present application is related to and claims the benefit under 35 U.S.C. §119(a) to a Korean patent application filed in the Korean Intellectual Property Office on Feb. 26, 2015, and assigned Serial number 10-2015-0027389, the entire disclosure of which is hereby incorporated by reference.

### TECHNICAL FIELD

The present disclosure relates to an electronic device including a battery. More particularly, the present disclosure relates to an electronic device to enable wirelessly charging.

### BACKGROUND

Wireless charging technologies are under development based on portable electronic devices such as smart phones. Wireless charging can be achieved using magnetic inductive charging or magnetic resonance charging.

By placing the power transmitter nearby in alignment with a power receiver coil, magnetic inductive charging charges a battery or runs a device using magnetic induction. The magnetic inductive charging can achieve high efficiency and high energy transmission.

Utilizing resonance that oscillates with a high amplitude at a particular frequency results in magnetic resonance charging. Power can be transferred using an electric current produced by the resonance by connecting one of two coils to a power source and the other one to an electronic device. The magnetic resonance charging can achieve the power transmission even when the distance between the power transmitter coil and the power receiver coil ranges from 1 m to 2 m.

An electronic device uses a chargeable battery. Such a battery is charged through wired charging using an electrical contact of the electronic device, or through the wireless charging using coils. The wireless charging may need a sufficient area to mount a wireless power transmission coil for the wireless charging.

### SUMMARY

To address the above-discussed deficiencies of the prior art, it is a primary aspect of the present disclosure to provide an apparatus and a method for wirelessly charging an electronic device using two or more auxiliary coils.

According to one aspect of the present disclosure, an electronic device includes a substrate; a main coil mounted on the substrate; and a plurality of auxiliary coils disposed near the main coil and electromagnetically coupled to the main coil, wherein the plurality of auxiliary coils are configured to wirelessly receive power from an external power source and transferred the power to the main coil via an electromagnetic interaction between the plurality of auxiliary coils and the main coil.

An electronic device comprising: a substrate; a main coil mounted on the substrate; and at least one auxiliary coil disposed near the main coil and electromagnetically coupled to the main coil, wherein the main coil is configured to receive an electromagnetic field generated by the at least one auxiliary coil.

Other aspects, advantages, and salient features of the invention will become apparent to those skilled in the art from the following detailed description, which, taken in conjunction with the annexed drawings, discloses embodiments of the invention.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

The above and other aspects, features, and advantages of certain embodiments of the present disclosure will be more apparent from the following description taken in conjunction with the accompanying drawings, in which:

FIG. 1 is a block diagram of an electronic device according to an embodiment of the present disclosure;

FIG. 2 is a diagram of wireless charging using magnetic resonance according to an embodiment of the present disclosure;

FIG. 3 is a diagram of an electronic device wirelessly charged using magnetic resonance according to an embodiment of the present disclosure;

FIG. 4 is a diagram of a circuit for wirelessly charging the electronic device of FIG. 3 according to an embodiment of the present disclosure;

FIG. 5 is a graph of resonant wireless charging efficiency in an electronic device using one main coil and one auxiliary coil;

FIG. 6 is a graph of resonant wireless charging efficiency in an electronic device according to an embodiment of the present disclosure;

FIG. 7 is a diagram of an electronic device wirelessly charged using magnetic resonance and magnetic induction according to an embodiment of the present disclosure;

FIG. 8 is a diagram of a single resonant coil using magnetic resonance in an electronic device and a resonant coil of a wireless charging pad;

FIG. 9 is a graph of wireless charging efficiency using magnetic resonance in the electronic device of FIG. 8;

FIG. 10 is a diagram of an auxiliary coil, a main coil, and a resonant coil of a wireless charging pad using magnetic resonance and magnetic induction in an electronic device according to an embodiment of the present disclosure;

FIG. 11 is a diagram of a circuit for wirelessly charging the electronic device of FIG. 10 according to an embodiment of the present disclosure;

FIG. 12 is a diagram of auxiliary coils, a main coil, and a resonant coil of a wireless charging pad using magnetic resonance and magnetic induction in an electronic device according to an embodiment of the present disclosure;

FIG. 13 is a diagram of a circuit for wirelessly charging the electronic device of FIG. 12 according to an embodiment of the present disclosure; and

FIG. 14 is a graph of wireless charging efficiency using magnetic resonance and magnetic induction in the electronic device of FIG. 13 according to an embodiment of the present disclosure.

Throughout the drawings, like reference numerals will be understood to refer to like parts, components and structures.

### DETAILED DESCRIPTION

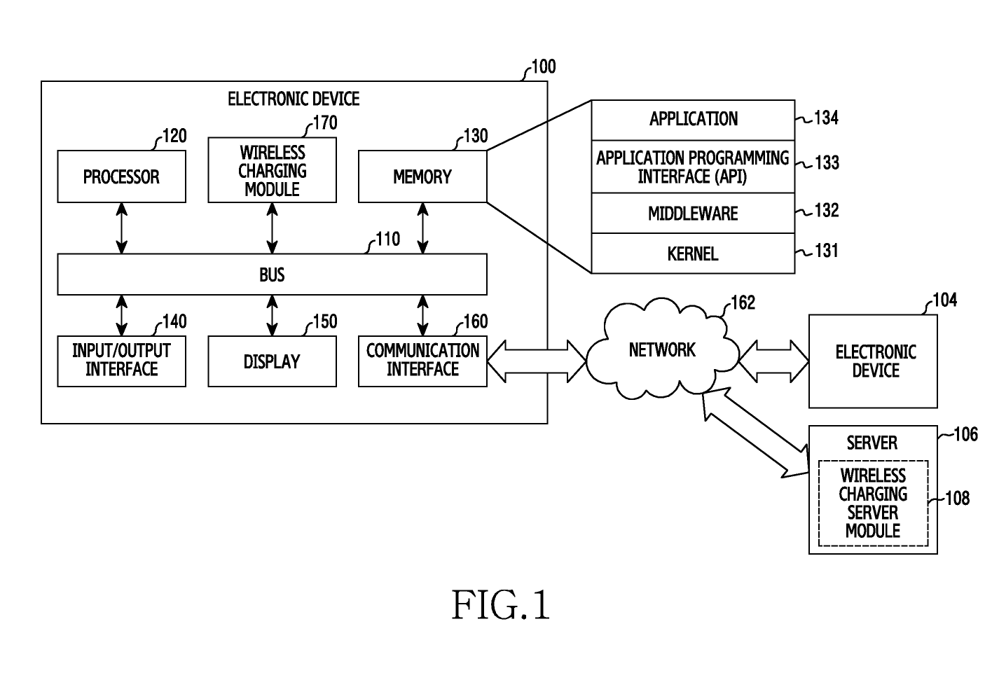

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Various embodiments of the present disclosure will be described herein with reference to the accompanying drawings, in which like reference numbers are used to depict the same or similar elements, features, and structures. Various modifications and changes to the embodiments of the present disclosure may be made without departing from the scope and spirit of the present disclosure. Specific embodiments are illustrated in the drawings and a related detailed description is provided. However, the embodiments described herein do not limit the present disclosure to a specific embodiment, and should be understood as including all modifications and equivalents or alternatives included in the spirit and technical scope of the present disclosure.

Before undertaking the DETAILED DESCRIPTION below, it may be advantageous to set forth definitions of certain words and phrases used throughout this patent document: the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, memory storing firmware or memory storing software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

The expressions “comprise” and “may comprise” as used herein indicate the existence of disclosed corresponding functions, operations, or constituent elements, etc. and do not limit additional functions, operations, or constituent elements, etc. Also, the terms “comprise” and “have” should be understood to designate the existence of features stated in the specification, numerals, steps, operations, constituent elements, components or a combination thereof, and not excluding the possibility of the existence or addition of one or more other features, numerals, steps, operations, constituent elements, components or combinations thereof.

As used herein, the term “or” includes any and all combinations of words enumerated together. For example, “A or B” may include A, or may include B, or may include A and B.

The terms “1st”, “2nd”, “first” or “second”, etc. as used herein may modify various constituent elements, but do not limit corresponding constituent elements. For example, the expressions do not limit the order and/or importance of the corresponding constituent elements. The expressions may be used to distinguish one constituent element from another constituent element. For example, both a first user device and a second user device are user devices and represent user devices different from one another. For example, a first constituent element may be referred to as a second constituent element without departing from the scope of the present disclosure. Likewise, a second constituent element may be referred to as a first constituent element.

When a constituent element is “connected” to or “accessed” by another constituent element, it is understood that the first constituent element may not only be directly connected to or accessed by the second constituent element, but also a new third constituent element may exist between the first constituent element and the second constituent element. On the other hand, when a constituent element is “directly connected” to or “directly accessed” by another constituent element, it is understood that no third constituent element exists between the first constituent element and the second constituent element. An item is “electromagnetically coupled” to another item means that both items are proximate and configured so that an electromagnetic field having a particular frequency at the one item induces an electromagnetic field or current at the other item. The terms used herein are used merely to explain embodiments of the present disclosure, and do not limit the various embodiments of the present disclosure.

An expression of a singular number includes the expression of a plural number unless the context clearly dictates otherwise.

Unless defined otherwise, all terms used herein, including technical or scientific terms, have the same meaning as those commonly understood by a person having ordinary knowledge in the art to which the present disclosure belongs. Terms as defined in a general dictionary should be interpreted as having meanings consistent with the contextual meanings of a related technology, and should not be interpreted as having ideal or excessively formal meanings unless explicitly defined herein.

An electronic device according to an embodiment of the present disclosure can be a device that includes a display function. For example, the electronic device can include at least one of a smart phone, a tablet Personal Computer (PC), a mobile phone, a video phone, an electronic book (e-book) reader, a desktop PC, a laptop PC, a netbook computer, a Personal Digital Assistant (PDA), a Portable Multimedia Player (PMP), an MPEG Audio Layer 3 (MP3) player, a mobile medical instrument, a camera, or a wearable device (e.g., a Head-Mounted Device (HMD) such as electronic glasses, electronic clothes, an electronic bracelet, an electronic necklace, an electronic accessory, an electronic tattoo, or a smart watch).

According to an embodiment of the present disclosure, the electronic device can be a smart home appliance having a display function. The smart home appliance, for example, the electronic device can include at least one of a television, a Digital Video Disk (DVD) player, an audio system, a refrigerator, an air conditioner, a cleaner, an oven, a microwave, a washing machine, an air cleaner, a set-top box, a TV box (for example, Samsung HomeSync®, Apple TV®, or Google TV®), a game console, an electronic dictionary, an electronic locking system, a camcorder, or an electronic picture frame.

According to an embodiment of the present disclosure, the electronic device may include at least one of various medical instruments (e.g., Magnetic Resonance Angiography (MRA) machine, Magnetic Resonance Imaging (MRI) machine, Computerized Tomography (CT) machine, a moving camera, an ultrasonic machine, etc.), a navigation device, a Global Positioning System (GPS) receiver, an Event Data Recorder (EDR), a Flight Data Recorder (FDR), a car infotainment device, an electronic equipment for ship (e.g., a navigation device for a ship and a gyrocompass, etc.), avionics, a security instrument, a head unit for vehicles, an industrial or home service robot, an Automatic Teller Machine (ATM), or a Point Of Sales (POS) machine.

According to an embodiment of the present disclosure, the electronic device can include at least one of a part of furniture or building/structure including a display function, an electronic board, an electronic signature receiving device, a projector, or various metering instruments (e.g., tap water, electricity, gas, or radio wave metering instrument, etc.).

The electronic device according to an embodiment of the present disclosure can be one of the aforementioned various devices or a combination of two or more of them. Also, the electronic device according to an embodiment of the present disclosure can be a flexible device. Also, the electronic device according to an embodiment of the present disclosure is not limited to the aforementioned instruments.

The term ‘user’ as used herein can denote a person who uses the electronic device or a device (e.g., an artificial-intelligence electronic device) which uses the electronic device.

Embodiments of the present disclosure provide a technique for wirelessly charging an electronic device.

FIG. 1 is a block diagram of an electronic device according to an embodiment of the present disclosure.

Referring to FIG. 1, the electronic device 100 can include a bus 110, a processor 120, a memory 130, an input/output interface 140, a display 150, a communication interface 160, and a wireless charging module 170. The wireless charging module 170 can be included in the processor 120 or in a separate module in association with the processor 120.

The bus 110 can be a circuit for interlinking the above-stated components and delivering communication signals (e.g., control messages) and/or data between the above-stated components.

The processor 120 can receive an instruction and/or data from the other components (e.g., the memory 130, the input/output interface 140, the display 150, the communication interface 160, or the wireless charging module 170) via the bus 110, interpret the received instruction, and process an operation or data according to the interpreted instruction.

The memory 130 can store instructions or data received from or generated by the processor 120 or the other components (e.g., the input/output interface 140, the display 150, the communication interface 160, or the wireless charging module 170).

For example, the memory 130 can store programming modules of a kernel 131, a middleware 132, an Application Programming Interface (API) 133, and an application 134. The programming modules can be implemented using software, firmware, or hardware, alone or in combination.

The kernel 131 can control or manage system resources (e.g., the bus 110, the processor 120, or the memory 130) used to execute the operation or the function of the other programming modules, for example, the middleware 132, the API 133, or the application 134. Also, the kernel 131 can provide an interface allowing the middleware 132, the API 133, or the application 134 to access and to control or manage the individual component of the electronic device 100.

The middleware 132 can relay data between the API 133 or the application 134 and the kernel 131. Also, for work requests received from the application 134, the middleware 132 can, for example, control (e.g., schedule or load balance) the work requests by giving priority of the system resource (e.g., the bus 110, the processor 120, or the memory 130) of the electronic device 100 to at least one application of the application 134.

The API 133, which is an interface for the application 134 to control the function provided from the kernel 131 or the middleware 132, can include at least one interface or function (e.g., instruction) for, for example, file control, window control, image processing, or text control.

The application 134 can include a Short Message Service (SMS/Multimedia Messaging Service (MMS) application, an e-mail application, a calendar application, an alarm application, a health care application (e.g., an application for measuring an exercise or a blood sugar level), or an environment information application (e.g., an application for providing air pressure, humidity, or temperature information). Additionally or alternatively, the application 134 can be an application relating to information exchange between the electronic device 100 and an another electronic device (e.g., an electronic device 104). The information exchange application can include, for example, a notification relay application for relaying particular information to the another electronic device, or a device management application for managing the another electronic device.

The input/output interface 140 can forward the instruction or the data input from a user through an input/output device (e.g., a sensor, a keyboard, or a touch screen) to, for example, the processor 120, the memory 130, the communication interface 160, or the wireless charging module 170 via the bus 110. For example, the input/output interface 140 can forward user's touch data input through the touch screen, to the processor 120. Also, the input/output interface 140 can output the instruction or the data received from the processor 120, the memory 130, the communication interface 160, or the wireless charging module 170 via the bus 110, through the input/output device (e.g., a speaker or a display). For example, the input/output interface 140 can output sound data processed by the processor 120 to the user through the speaker.

The display 150 can display various information (e.g., multimedia data or text data) to the user.

The communication interface 160 can connect the communication between the electronic device 100 and the another electronic device (e.g., the electronic device 104 or a server 106). For example, the communication interface 160 can communicate with the another electronic device over a network 162 using wireless communication or wired communication. For example, the wireless communication can include at least one of Wireless Fidelity (WiFi), Bluetooth (BT), Near Field Communication (NFC), Global Positioning System (GPS), and cellular communication (e.g., Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), or Global System for Mobile Communications (GSM)). The wired communication can include at least one of, for example, Universal Serial Bus (USB), High Definition Multimedia Interface (HDMI), Recommended Standard (RS) 232, and Plain Old Telephone Service (POTS).

The network 162 can be a telecommunications network. The telecommunications network can include at least one of a computer network, Internet, Internet of things, and a telephone network. A protocol (e.g., transport layer protocol, data link layer protocol, or physical layer protocol) for the communication between the electronic device 100 and the another electronic device can be supported by at least one of the application 134, the API 133, the middleware 132, the kernel 131, and the communication interface 160.

The wireless charging module 170 can receive power from a wireless power supply device (e.g., a wireless charging pad).

The wireless charging module 170 can receive the power from the wireless charging pad using magnetic resonance. For example, the wireless charging module 170 can include can a main coil and a plurality of auxiliary coils near the main coil. The auxiliary coils can be electrically coupled to the main coil. Herein, the auxiliary coils and the main coil can serve as magnetic resonant coils for the magnetic resonance. For example, the auxiliary coils can receive power from a high-frequency signal or electromagnetic field (high-frequency power) from at least one resonant coil of the wireless charging pad. The auxiliary coils are electromagnetically coupled to the main coil in manner to transfer the received power to the main coil.

The wireless charging module 170 can receive the power induced to the auxiliary coil from the wireless charging pad using the magnetic resonance. For example, the wireless charging module 170 can include a main coil and at least one auxiliary coil near the main coil. The at least one auxiliary coil can be electrically coupled with the main coil. Herein, the at least one auxiliary coil can serve as a magnetic resonant coil the magnetic resonance, and the main coil can receive a magnetic field induced by the resonant coil. For example, the at least one auxiliary coil can receive high-frequency power from at least one resonant coil of the wireless charging pad through the coupling. Herein, the at least one auxiliary coil and the at least one resonant coil of the wireless charging pad can generate an electromagnetic field, and the main coil and receive the electromagnetic field.

The server 106 can support driving of the electronic device 100 by performing at least one of the operations (or functions) of the electronic device 100. For example, the server 106 can include a wireless charging server module 108 for supporting the wireless charging module 170 of the electronic device 100. The wireless charging server module 108 can include at least one component of the wireless charging module 170 and thus perform (e.g., execute) at least one of the operations of the wireless charging module 170.

The wireless charging module 170 can process at least part of information obtained from the other components (e.g., the processor 120, the memory 130, the input/output interface 140, or the communication interface 160), and provide the processed information to the user in various manners. For example, by use of or independently from the processor 120, the wireless charging module 170 can control at least some function of the electronic device 100 so that the electronic device 100 can interwork with the other electronic device (e.g., the electronic device 104 or the server 106). At least one component of the wireless charging module 170 can be included in the server 106 (e.g., the wireless charging server module 108), and the server 106 can support at least one operation of the wireless charging module 170.

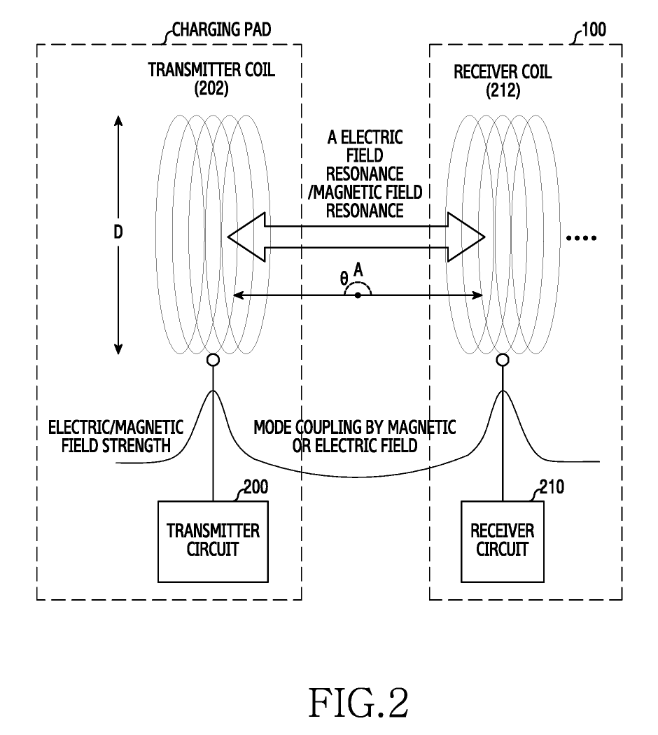

FIG. 2 depicts wireless charging using magnetic resonance according to an embodiment of the present disclosure.

Referring to FIG. 2, an electronic device (e.g., the electronic device 100) can receive power from a wireless charging pad (a transmitter) using the magnetic resonance. For example, magnetic resonance transfers non-radiative electric wave energy between resonant circuits that apart from each other. The magnetic resonance is similar to the magnetic induction, but can achieve then wireless power transfer across about 1˜2 m. The magnetic resonance can use a resonant circuit for amplifying and transferring the energy.

The magnetic resonance can utilize coils 202 and 212 in transmitter and receiver circuits 200 and 210, respectively. For example, the magnetic resonance can adopt electric or magnetic field resonance. Transmission efficiency of the magnetic resonance depends on coil alignment requirements, whereas it is easy to align the coils compared with the magnetic induction and a magnetic resonance range can expand using relay.

The wireless charging pad can include a high-frequency power source and at least one resonant coil, such as transmitter coil 202. The high-frequency power source can output high-frequency power at about, for example, several MHz. The at least one resonant coil can be electrically connected to the high-frequency power source.

The electronic device 100 can include a plurality of auxiliary coils, such as receiver coil 212, a main coil, and a rectifier or a converter. Herein, the auxiliary coils and the main coil can serve as magnetic resonant coils for the magnetic resonance. For example, the auxiliary coils, e.g., receiver coil 212, can receive high-frequency power from at least one resonant coil of the wireless charging pad, e.g., transmitter coil 202 and transfer the high-frequency power to the main coil through the coupling. Hence, the main coil can receive the high-frequency power from the auxiliary coils.

The main coil can be mounted on a substrate of the electronic device 100 and electrically coupled with the auxiliary coils. The main coil can be electrically connected to the rectifier. The rectifier can convert the high-frequency power received at the main coil to direct current and send the direct current to a load (a battery) through a switching circuit. As such, the electronic device 100 can charge its battery from the wireless charging pad, and manage the wireless charging using a wireless charging controller. The electronic device 100 can further include various components for the wireless charging using the magnetic resonance.

A difference of the transmission efficiency and the reception efficiency can be determined based on a resonance factor Q between inductance/capacitance (LCs) of the resonant coils 202 and 212 and a coupling coefficient k of the coils. For example, the transmission efficiency of the magnetic or electric resonance can be determined based on a transmission distance A, a coil diameter D, and an angle θ between the coils.

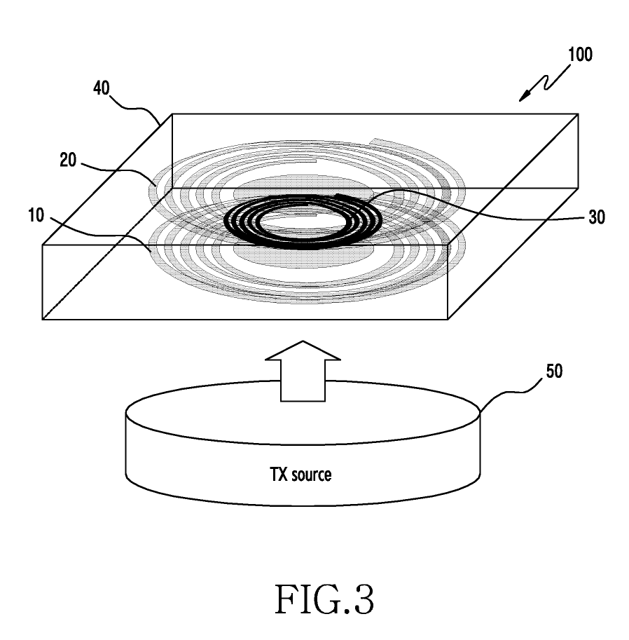

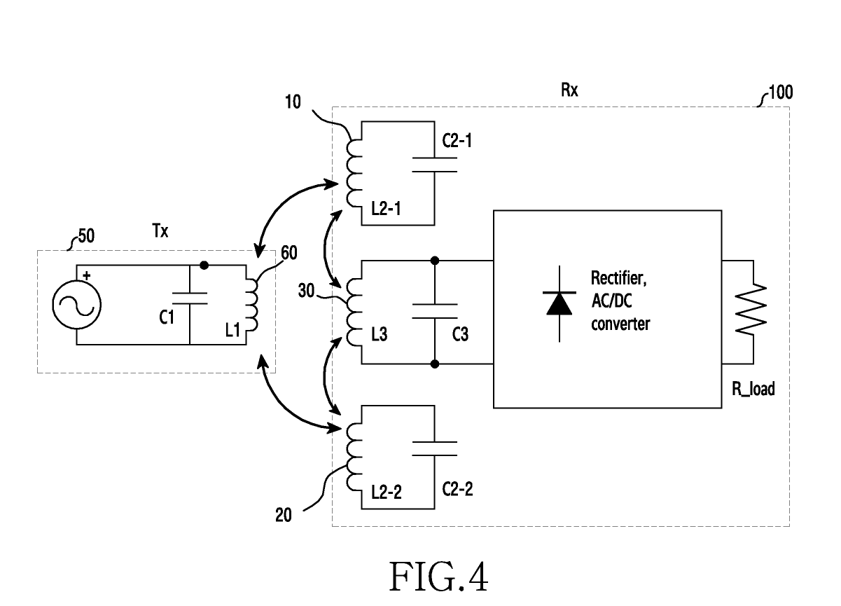

FIG. 3 depicts an electronic device wirelessly charged using magnetic resonance according to an embodiment of the present disclosure. FIG. 4 depicts a circuit for wirelessly charging the electronic device of FIG. 3 according to an embodiment of the present disclosure.

Referring to FIGS. 3 and 4, the electronic device 100 can include a plurality of auxiliary coils 10 and 20 and a main coil 30 for receiving power from a wireless charging pad 50. Herein, the auxiliary coils 10 and 20 and the main coil 30 can serve as magnetic resonant coils for the magnetic resonance.

The electronic device 100 can receive high-frequency power in proximity to the wireless charging pad 50. For example, a resonant coil 60 of the wireless charging pad 50 generates a magnetic field by oscillating at a resonant frequency. The auxiliary coils 10 and 20 of the electronic device 100 of the same resonant frequency can also resonate in response to the magnetic field and receive the induced power.

The electronic device 100 can include a case frame 40 for forming its exterior, the auxiliary coils 10 and 20 disposed in the case frame 40, the main coil 30, a substrate, a switching circuit, and a rectifier or a converter.

The auxiliary coils 10 and 20 can include the first auxiliary coil 10 and the second auxiliary coil 20 as shown in FIG. 3. For example, the first auxiliary coil 10 and the second auxiliary coil 20 can be disposed away from the main coil 30 and attached to the case frame 40. The first auxiliary coil 10 and the second auxiliary coil 20 can be attached to an inner side of the case frame 40 and insert-molded in the case frame 40. An area of the first auxiliary coil 10 and the second auxiliary coil 20 can be at least greater than an area of the main coil 30. The first auxiliary coil 10 and the second auxiliary coil 20 have the same area and have a concentric circle at their vertically overlapping position. The first auxiliary coil 10 and the second auxiliary coil 20 can be in, but not limited to, a spiral shape. The first auxiliary coil 10 and the second auxiliary coil 20 can be stuck in both inner sides of the case frame 40 as thin films. The first auxiliary coil 10 and the second auxiliary coil 20 can be printed or deposited onto the inner side of the case frame 40.

The main coil 30 can be interposed between the first auxiliary coil 10 and the second auxiliary coil 20 as shown in FIG. 3. For example, the main coil 30 can be mounted or printed and plated on the substrate. For example, when the main coil 30 is implemented using a Flexible Printed Circuit Board (FPCB), the main coil 30 can be electrically connected to a main board.

The main coil 30 can differ from the auxiliary coils 10 and 20 in the area, and be disposed coaxially at the vertically overlapping position of the auxiliary coils 10 and 20. For example, the main coil 30 can be positioned in the middle between the auxiliary coils 10 and 20. The area of the main coil 30 can be smaller than the area of the auxiliary coils 10 and 20.

When the electronic device 100 approaches the wireless charging pad 50 within a certain distance, the resonant coil 60 of the wireless charging pad 50 and the first and second auxiliary coils 10 and 20 of the electronic device 100 can resonate at the same resonant frequency. For example, the first and second auxiliary coils 10 and 20 can receive the high-frequency power from the resonant coil 60 of the wireless charging pad 50 through the coupling. The first and second auxiliary coils 10 and 20 can forward the high-frequency power received from the resonant coil 60 of the wireless charging pad 50, to the main coil 30 through the coupling. The first and second auxiliary coils 10 and 20 can concentrate the electromagnetic field from the wireless charging pad 50 toward the main coil 30. Hence, the main coil 30 can receive the high-frequency power from the first and second auxiliary coils 10 and 20.

The main coil 30 can be mounted on a substrate and electrically coupled to the first and second auxiliary coils 10 and 20. The main coil 30 can be electrically connected to the rectifier. The rectifier can convert the high-frequency power of the main coil 30 to a direct current, and the current converted by the rectifier can be stored in the load (the battery) through the switching circuit. Hence, the electronic device 100 can charge the battery from the wireless charging pad 50 and manage the wireless charging using the wireless charging controller. The wireless charging pad 50 and the electronic device 100 can further include various components for the resonant wireless charging.

The first auxiliary coil 10, the second auxiliary coil 20, and the main coil 30 of the electronic device 100 can be designed to resonate at the same frequency. A value fᵣₑₛ indicating the same frequency can be calculated based on Equation 1.

$${f}_{res} = \frac{1}{2 π \sqrt{{L}_{2 - 1} {C}_{2 - 1}}} = \frac{1}{2 π \sqrt{{L}_{2 - 2} {C}_{2 - 2}}} = \frac{1}{2 π \sqrt{{L}_{3} {C}_{3}}} \qquad ( 1 )$$

fᵣₑₛ denotes the same resonant frequency of the coils 10, 20 and 30, L denotes inductance of the coils 10, 20 and 30, and C denotes capacitance of the coils 10, 20 and 30. Hence, the three coils 10, 20 and 30 can resonate at the same frequency. The auxiliary coils of the electronic device 100 include, but not limited to, the two resonant coils. For example, the auxiliary coils can include two or more resonant coils.

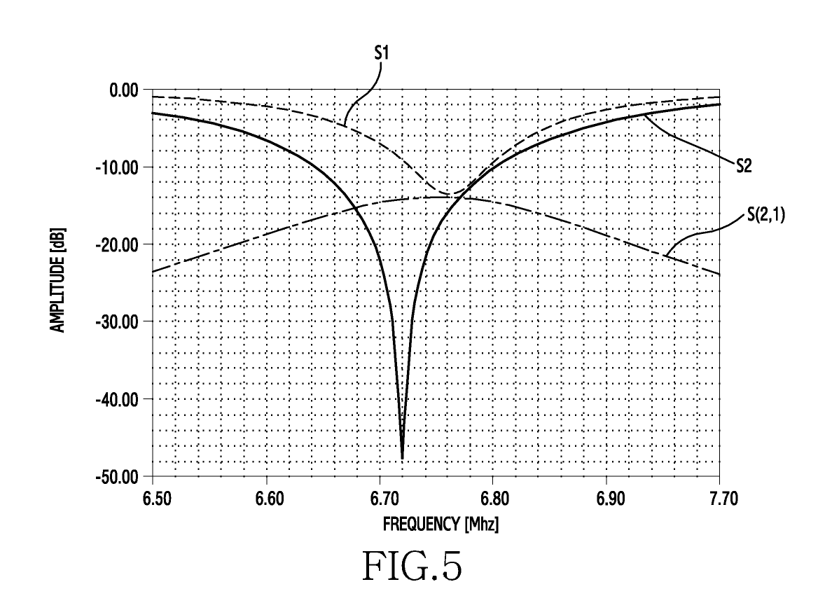

FIG. 5 is a graph of resonant wireless charging efficiency in an electronic device using one main coil and one auxiliary coil.

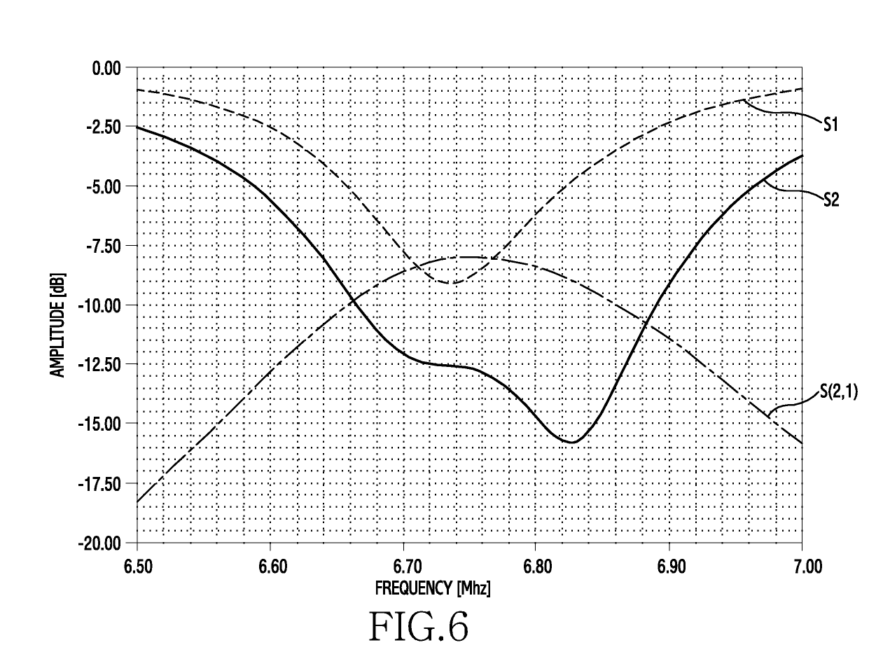

FIG. 6 is a graph of resonant wireless charging efficiency in an electronic device using one main coil and two auxiliary coils according to an embodiment of the present disclosure.

In FIGS. 5 and 6, the horizontal axis is the frequency, while the vertical axis for S(2, 1) is decibels (dB), 20 log 10(S2/S1) and amplitude for curves S1 and S2. Curve S1 represents the amplitude of the output power of the transmitter, and curve S2 represents the amplitude of the power of the receiver.

As shown in FIGS. 5 and 6, the resonant wireless charging efficiency using one main coil and one auxiliary coil is measured at about −14 dB, and the wireless charging efficiency using one main coil and a plurality of auxiliary coils is measured at about −8 dB. Herein, values corresponding to S(2,1) indicating the wireless charging efficiency can be produced by dividing power output from a power receiver S2 by power input from a transmitter S1. Hence, the present wireless charging can achieve a wireless charging efficiency gain of about 6 dB compared with the conventional wireless charging efficiency.

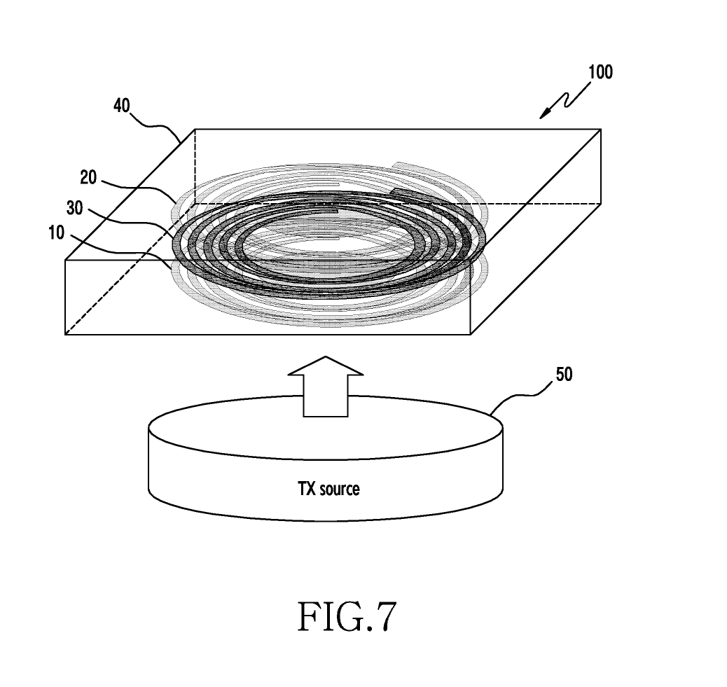

FIG. 7 depicts an electronic device wirelessly charged using magnetic resonance and magnetic induction according to an embodiment of the present disclosure.

Referring to FIG. 7, the electronic device 100 can include one or more auxiliary coils 10 and 20 and a main coil 30 for receiving power from a wireless charging pad 50. Herein, the auxiliary coils 10 and 20 can serve as a magnetic resonant coil for the magnetic resonance, and the main coil 30 can serve as a magnetic inductive coil for the magnetic induction.

As a resonant coil of the wireless charging pad 50 oscillates at a resonant frequency, the wireless charging pad 50 generates an electromagnetic field. The auxiliary resonant coils 10 and 20 of the electronic device 100 of the same resonant frequency can also resonate in response to the electromagnetic field. For example, the main coil 30 can receive the high-frequency power by inducing the electromagnetic field generated by the resonant coil of the wireless charging pad 50 and the auxiliary resonant coils 10 and 20 of the electronic device 100. The main coil 30 can receive some of the electromagnetic field induced from the resonant coil of the wireless charging pad 50. Herein, the main coil 30 can operate at a different frequency from the resonant frequency of the auxiliary resonant coils 10 and 20.

The electronic device 100 can include a housing 40 forming its exterior, the one or more auxiliary coils 10 and 20 in the housing 40, the main coil 30, a substrate, a switching circuit, and a rectifier or a converter.

The one or more auxiliary coils 10 and 20 can include the first auxiliary coil 10 and the second auxiliary coil 20 as shown in FIG. 7. For example, the first auxiliary coil 10 and the second auxiliary coil 20 can be spaced from the main coil 30 and attached to the housing 40. The first auxiliary coil 10 and the second auxiliary coil 20 can be attached to an inner side of the housing 40 using insert-molding.

The first auxiliary coil 10 and the second auxiliary coil 20 can serve as magnetic resonant coils for the magnetic resonance, and the main coil 30 can serve as a magnetic inductive coil for the magnetic induction. Herein, the main coil 30 can receive power by inducing an electromagnetic field generated by the first auxiliary coil 10 and the second auxiliary coil 20 and a resonant coil of the wireless charging pad 50. The area of the main coil 30 can be greater than or equal to the area of the first auxiliary coil 10 and the second auxiliary coil 20. For example, the first auxiliary coil 10, the second auxiliary coil 20, and the main coil 30 can have the same area and a concentric circle at their vertically overlapping position. The first auxiliary coil 10, the second auxiliary coil 20, or the main coil 30 can be in, but not limited to, a spiral shape.

The first auxiliary coil 10 and the second auxiliary coil 20 can be, as thin films, stuck to both inner sides of the housing 40. The first auxiliary coil 10 and the second auxiliary coil 20 can be printed or deposited on the inner side of the housing 40.

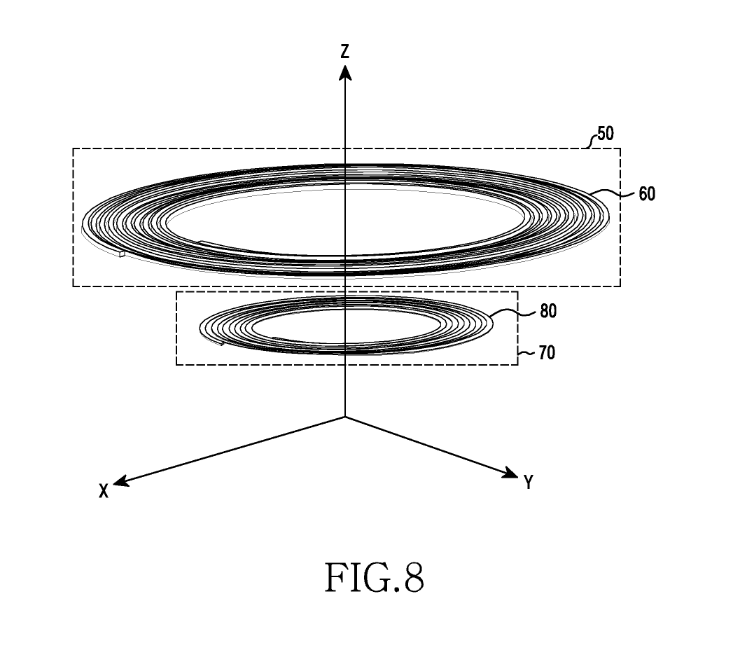

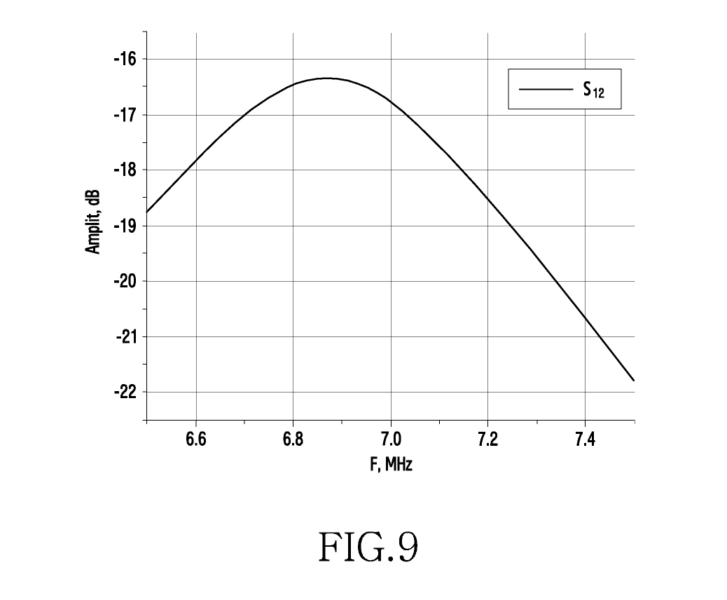

FIG. 8 depicts a resonant coil using magnetic resonance in an electronic device having a single coil 80, and a resonant coil 60 of a wireless charging pad. FIG. 9 is a graph of resonant wireless charging efficiency in the electronic device of FIG. 8.

Referring to FIG. 8, the electronic device 70 can be wirelessly charged using the magnetic resonance. For example, the electronic device 70 can include a resonant coil 80 for the magnetic resonance. The resonant coil 80 of the electronic device 70 can receive high-frequency power from a resonant coil 60 of a wireless charging pad 50 through the coupling. As a result, wireless charging efficiency simulation results show that the conventional resonant wireless charging efficiency using the single resonant coil 80 in the electronic device 70 is about −16.3 dB near 6.9 MHz frequency as shown in FIG. 9.

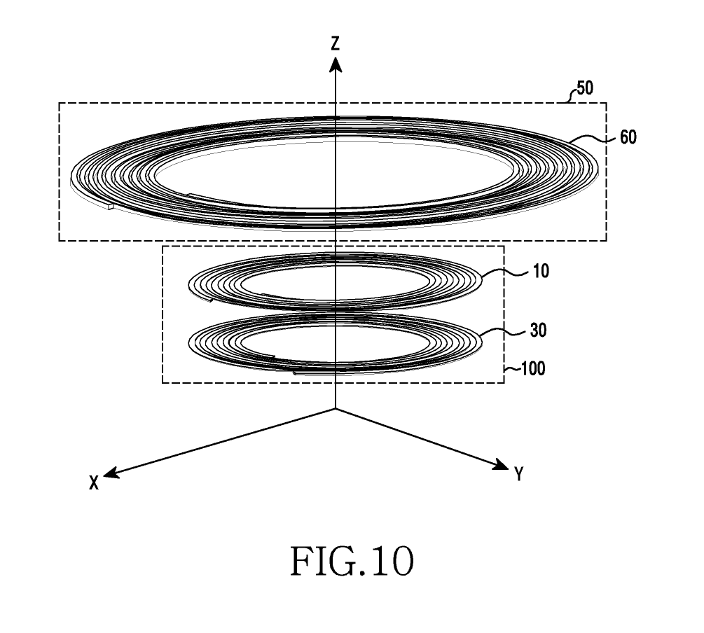

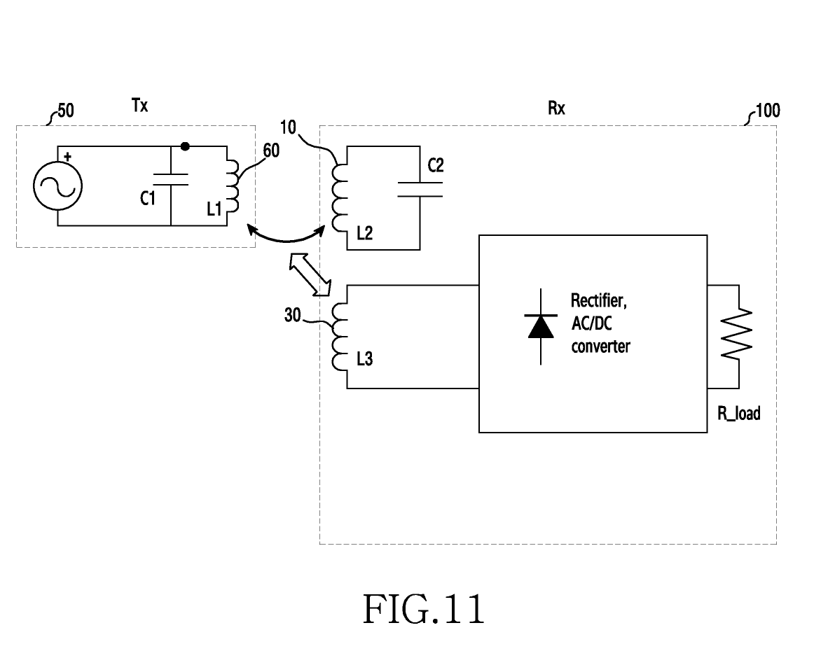

FIG. 10 depicts an auxiliary coil 10, and a main coil 30 of an electronic device 100, and a resonant coil 50 of a wireless charging pad 50 using magnetic resonance and magnetic induction in an electronic device according to an embodiment of the present disclosure. FIG. 11 depicts a circuit for wirelessly charging the electronic device of FIG. 10 according to an embodiment of the present disclosure.

Referring now to FIGS. 10 and 11, a wireless charging circuit of the electronic device 100 can include an auxiliary coil 10, a main coil 30, a switching circuit, and a rectifier or a converter. For example, the electronic device 100 can include the auxiliary coil 10 and the main coil 30 for receiving power from a wireless charging pad 50. Herein, the auxiliary coil 10 can serve as a magnetic resonant coil for the magnetic resonance, and the main coil 30 can serve as a magnetic inductive coil for the magnetic induction.

As a resonant coil 60 of the wireless charging pad 50 oscillates at a resonant frequency, the wireless charging pad 50 generates an electromagnetic field. The auxiliary resonant coil 10 of the electronic device 100 of the same resonant frequency can also resonate in response to the electromagnetic field. The main coil 30 can receive the high-frequency power by inducing the electromagnetic field generated by the resonant coil 60 of the wireless charging pad 50 and the auxiliary resonant coil 10 of the electronic device 100. Since the main coil 30 is disposed near the auxiliary coil 10 in the electronic device 100, it is easy to induce the electromagnetic field generated by the resonant coil 60 of the wireless charging pad 50 and the auxiliary resonant coil 10 of the electronic device 100.

When the electronic device 100 approaches the wireless charging pad 50 within a certain distance, the resonant coil 60 of the wireless charging pad 50 and the auxiliary coil 10 of the electronic device 100 can resonate at the same resonant frequency. The auxiliary coil 10 can receive the high-frequency power from the resonant coil 60 of the wireless charging pad 50 through the coupling. The main coil 30 can receive the high-frequency power by inducing the electromagnetic field generated by the auxiliary resonant coil 10 and the resonant coil 60 of the wireless charging pad 50. The main coil 30 can receive some of the electromagnetic field from the resonant coil 60 of the wireless charging pad 50.

The first auxiliary coil 10 of the electronic device 100 can be designed to resonate at frequency fᵣₑₛ based on Equation 2.

fᵣₑₛ=1/2π√L₂C₂ (2)

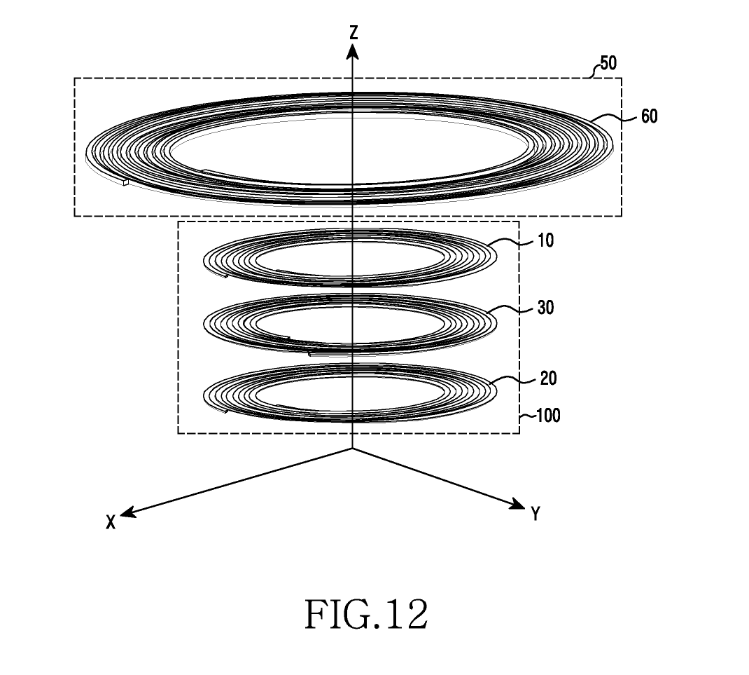

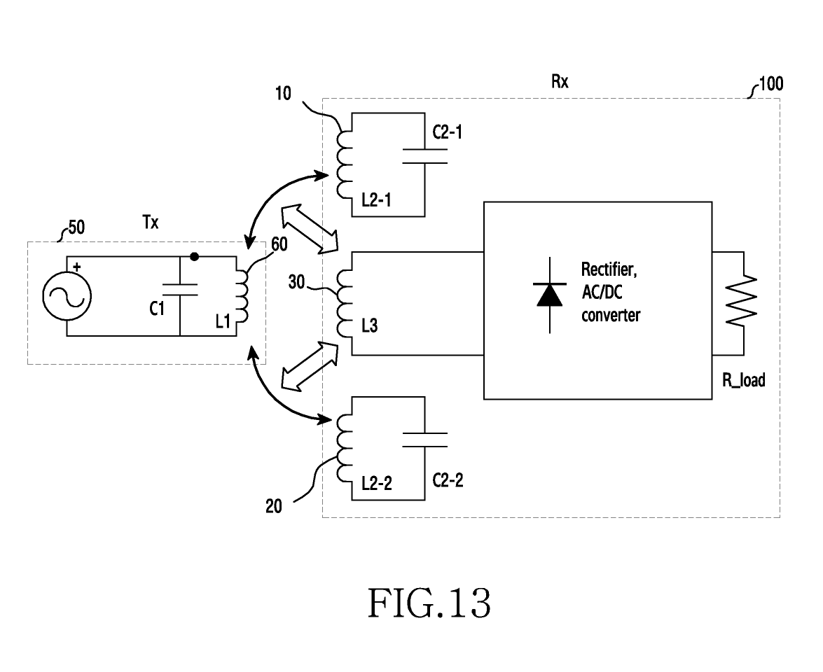

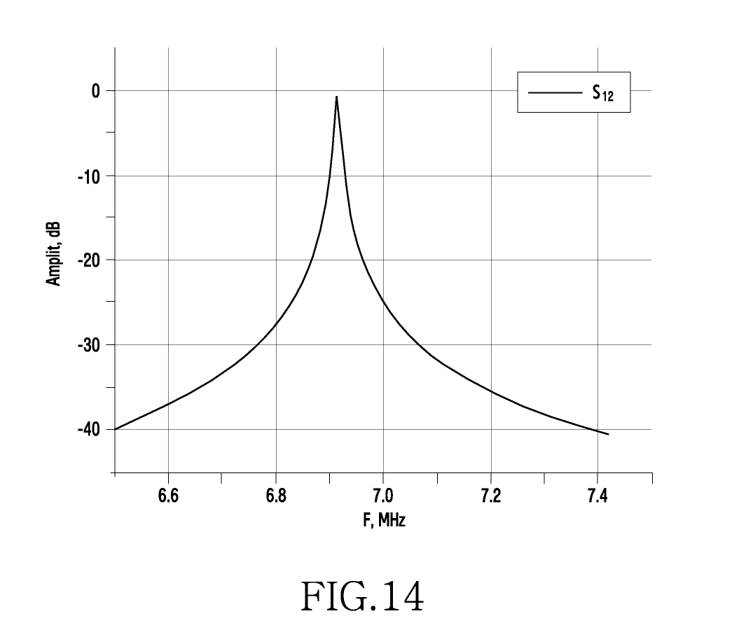

FIG. 12 depicts auxiliary coils, a main coil, and a resonant coil of a wireless charging pad using magnetic resonance and magnetic induction in an electronic device according to an embodiment of the present disclosure. FIG. 13 depicts a circuit for wirelessly charging the electronic device of FIG. 12 according to an embodiment of the present disclosure. FIG. 14 is a graph of wireless charging efficiency using the magnetic resonance and the magnetic induction in the electronic device of FIG. 13 according to an embodiment of the present disclosure.

Referring to FIGS. 12 and 13, a wireless charging circuit of the electronic device 100 can include two auxiliary coils 10 and 20, a main coil 30, a switching circuit, and a rectifier or a converter. For example, the electronic device 100 can include the auxiliary coils 10 and 20 and the main coil 30 for receiving power from a wireless charging pad 50. Herein, the auxiliary coils 10 and 20 can serve as magnetic resonant coils for the magnetic resonance, and the main coil 30 can serve as a magnetic inductive coil for the magnetic induction.

As a resonant coil 60 of the wireless charging pad 50 oscillates at a resonant frequency, the wireless charging pad 50 generates an electromagnetic field. The auxiliary coils 10 and 20 of the electronic device 100 of the same resonant frequency can also resonate in response to the electromagnetic field. The main coil 30 can receive the high-frequency power by inducing the electromagnetic field generated by the resonant coil 60 of the wireless charging pad 50 and the auxiliary coils 10 and 20 of the electronic device 100. Since the main coil 30 is disposed near the auxiliary coils 10 and 20 in the electronic device 100, it is easy to induce the electromagnetic field generated by the resonant coil 60 of the wireless charging pad 50 and the auxiliary coils 10 and 20 of the electronic device 100.

The first auxiliary coil 10, and the second auxiliary coil 20 of the electronic device 100 can be designed to resonate at the same frequency. A value fᵣₑₛ indicating the same frequency can be calculated based on Equation 3.

fᵣₑₛ=1/2π√L₂₋₁C₂₋₁=1/2π√L₂₋₂C₂₋₂ (3)

The area of the main coil 30 can be greater than or equal to the area of auxiliary coils 10 and 20. For example, the auxiliary coils 10 and 20 and the main coil 30 can have the same area and a concentric circle at their vertically overlapping position.

When the electronic device 100 approaches the wireless charging pad 50 within a certain distance, the resonant coil 60 of the wireless charging pad 50 and the auxiliary coils 10 and 20 of the electronic device 100 can resonate at the same resonant frequency. The auxiliary coils 10 and 20 can receive the high-frequency power from the resonant coil 60 of the wireless charging pad 50 through the coupling. The main coil 30 can receive the high-frequency power by inducing the electromagnetic field generated by the auxiliary coils 10 and 20 and the resonant coil 60 of the wireless charging pad 50. The main coil 30 can receive some of the induced electromagnetic field from the resonant coil 60 of the wireless charging pad 50.

As such, wireless charging efficiency simulation results show that the present wireless charging efficiency using the two auxiliary coils 10 and 20 and the single main coil 30 in the electronic device 100 is about −0.03 dB near 6.9 MHz frequency as shown in FIG. 14. The present wireless charging can achieve a wireless charging efficiency gain of about 16 dB compared with the electronic device and charging pad of FIG. 8.

An electronic device can include a substrate; a main coil mounted on the substrate; and a plurality of auxiliary coils disposed near the main coil and electrically or electromagnetically coupled to the main coil, wherein wireless power received is transferred to the main coil using resonance of the auxiliary coils.

The auxiliary coils can be disposed in an inner side of a housing of the electronic device.

The auxiliary coils can be attached as thin films to the inner side of the housing of the electronic device.

The auxiliary coils can be disposed in at least two inner sides of the housing with the main coil between the auxiliary coils.

The auxiliary coils can be insert-molded in a housing of the electronic device.

The auxiliary coils can be at least greater than the main coil in an area.

Two auxiliary coils can be disposed at intervals with the main coil between the auxiliary coils.

An electronic device can include a substrate; a main coil mounted on the substrate; and at least one auxiliary coil disposed near the main coil and electrically or electromagnetically coupled to the main coil, wherein the main coil receives an electromagnetic field generated by the at least one auxiliary coil.

The at least one auxiliary coil can be disposed in an inner side of a housing of the electronic device.

The at least one auxiliary coil can be attached as a thin film to the inner side of the housing of the electronic device.

The at least one auxiliary coil can be disposed in at least two inner sides of the housing with the main coil between the auxiliary coils.

The at least one auxiliary coil can be insert-molded in a housing of the electronic device.

The main coil can be at least greater than the at least one auxiliary coil in an area.

With a plurality of auxiliary coils, two auxiliary coils can be disposed at intervals with the main coil between the auxiliary coils.

The aforementioned components of the electronic device according to various embodiments of the present disclosure each may include one or more components, and the name of the corresponding component may differ according to the type of the electronic device. The present electronic device may include at least one of the aforementioned components, omit some components, or further include other components. Also, some of the components of the present electronic device may be united into a single entity to thus carry out the same functions of the corresponding components.

The term “module” used in an embodiment of the present disclosure indicates, for example, a unit including a combination of one or more of hardware, memory storing software, or memory storing firmware. The “module” may be interchangeably used with the terms, for example, “a unit,” “logic,” “a logical block,” “a component,” or “a circuit.” The “module” may be a minimum unit or part of the components integrally formed. The “module” may be a minimum unit or part of one or more functions. The “module” may be implemented mechanically or electronically. For example, the “module” may include at least one of an Application-Specific Integrated Circuit (ASIC), a Field-Programmable Gate Array (FPGA), or a programmable-logic device for performing operations which are well known or will be developed.

As set forth above, the power received at the plurality of the auxiliary resonant coils is transferred to the main resonant coil in the electronic device, and thus the wireless charging efficiency of the electronic device can be enhanced.

Since the main coil receives the power by inducing the electromagnetic field generated by at least one auxiliary resonant coil in the electronic device, the wireless charging efficiency of the electronic device can be improved.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An electronic device comprising:
a substrate;
a main coil mounted on the substrate; and
a plurality of auxiliary coils disposed near the main coil and electromagnetically coupled to the main coil,
wherein the plurality of auxiliary coils are configured to wirelessly receive power from an external power source and transferred the power to the main coil via an electromagnetic interaction between the plurality of auxiliary coils and the main coil.

2. The electronic device of claim 1, wherein the auxiliary coils are disposed in an inner side of a housing of the electronic device.

3. The electronic device of claim 2, wherein at least one of the plurality of auxiliary coils includes a thin film coupled to the inner side of the housing of the electronic device.

4. The electronic device of claim 1, wherein the plurality auxiliary coils are disposed in at least two inner sides of the housing, and wherein the main coil is between the auxiliary coils.

5. The electronic device of claim 1, wherein the plurality of auxiliary coils are insert-molded in a housing of the electronic device so that the plurality of auxiliary coils and the housing are coupled with each other.

6. The electronic device of claim 1, wherein the area of the plurality of auxiliary coils are at least greater than the area of the main coil.

7. The electronic device of claim 1, wherein the plurality of auxiliary coils include two auxiliary coils, and wherein the main coil is disposed between the two auxiliary coils.

8. The electronic device of claim 1, wherein the plurality of auxiliary coils are further configured to receive the power from an electromagnetic field generated proximate to the auxiliary coils.

9. An electronic device comprising:
a substrate;
a main coil mounted on the substrate; and
at least one auxiliary coil disposed near the main coil and electromagnetically coupled to the main coil,
wherein the main coil is configured to receive an electromagnetic field generated by the at least one auxiliary coil.

10. The electronic device of claim 9, wherein the at least one auxiliary coil is disposed in an inner side of a housing of the electronic device.

11. The electronic device of claim 10, wherein the at least one auxiliary coil includes a thin film coupled to the inner side of the housing of the electronic device.

12. The electronic device of claim 10, wherein the at least one auxiliary coil is disposed in at least two inner sides of the housing, and wherein the main coil is between the auxiliary coils.

13. The electronic device of claim 9, wherein the at least one auxiliary coil is insert-molded in a housing of the electronic device so that the at least one auxiliary coil and the housing are coupled with each other.

14. The electronic device of claim 9, wherein the area of the main coil is at least greater than the area of the at least one auxiliary coil.

15. The electronic device of claim 9, wherein the at least one auxiliary coil includes two auxiliary coils, and wherein the main coil is disposed between the two auxiliary coils.

16. The electronic device of claim 9, wherein the at least one auxiliary coil is further configured to receive power from an electromagnetic field generated proximate to the at least one auxiliary coil.
